(19) United States
(12) Patent Application Publication
(10) Pub. No.: US 2025/0273452 A1
(43) Pub. Date: Aug. 28, 2025

(54) ION GUIDE AND MASS SPECTROMETER

(71) Applicant: HITACHI HIGH-TECH CORPORATION, Tokyo (JP)

(72) Inventors: Hideki HASEGAWA, Tokyo (JP); Masuyuki SUGIYAMA, Tokyo (JP)

(21) Appl. No.: 18/857,632

(22) PCT Filed: Jun. 12, 2023
(86) PCT No.: PCT/JP2023/021787

§ 371 Date: Oct. 17, 2024

(30) Foreign Application Priority Data
Jul. 11, 2022 (JP) 2022-110980

(51) Int. Cl. H01J 49/06

(52) U.S. Cl. CPC H01J 49/065

(57) ABSTRACT

An ion guide and a mass spectrometer that has both high ion uptake efficiency and high ion focusing efficiency. In the ion guide, an ion travels in an internal space from an inlet side toward an outlet side. The ion guide includes plate electrodes stacked at intervals in a stacking direction orthogonal to a traveling direction in which the ion travels. At least two plate electrodes, are inclined plate electrodes having an inclined surface inclined with respect to the traveling direction in a part facing the internal space. Each of the inclined plate electrodes has an inclination start point at which the inclined surface starts on an end surface on the inlet side, and positions of the inclination start points in a direction orthogonal to both the traveling direction and the stacking direction are different for at least two of the inclined plate electrodes adjacent in the stacking direction.

### TECHNICAL FIELD

The present invention relates to an ion guide and a mass spectrometer, and for example, relates to those that can achieve both high ion uptake efficiency and high ion focusing efficiency.

### BACKGROUND ART

In a mass spectrometer, ions generated by an ion source are transported to a mass spectrometry unit by an ion transport unit. A mass spectrometer using an atmospheric pressure ionization method generally has a device configuration of a differential pumping system in which a vacuum chamber is divided into a plurality of sections in order to transport ions generated under atmospheric pressure to the mass spectrometry unit in vacuum. In this case, the ion transport unit is often disposed in a differential pumping chamber having a low degree of vacuum and a high pressure on a front stage side. In order to achieve high sensitivity of the mass spectrometer, the ion transport unit is required to have high ion uptake efficiency and high ion focusing efficiency.

For a general ion transport unit, an ion guide method of focusing ions using a radio-frequency electric field formed by applying a radio-frequency voltage is used. As the ion guide, an ion funnel method in which ring-shaped electrodes are stacked in an ion transport direction, a multipole ion guide method including a plurality of rod electrodes, or the like is used.

In PTL 1, an ion guide of about 12 poles is achieved by configuring a multipole with a electrodes having trapezoidal cross-sectional shape.

### CITATION LIST

### Patent Literature

PTL 1: U.S. Pat. No. 10,475,633

### SUMMARY OF INVENTION

### Technical Problem

In the ion funnel method, since ring-shaped electrodes are stacked in the ion transport direction, ions are likely to collide with the electrode surface, and the electrode may be likely to be contaminated. On the other hand, in the multipole ion guide method, generally, the larger the number of electrodes (number of poles), the higher the ion uptake efficiency. In PTL 1, since the trapezoidal electrodes are arranged radially, it is considered difficult to increase the number of electrodes by further miniaturization. That is, it is considered that there is a problem in further improving the ion uptake efficiency.

The present invention has been made to solve such problems, and an object of the present invention is to provide an ion guide and a mass spectrometer that can achieve both high ion uptake efficiency and high ion focusing efficiency.

### Solution to Problem

An example of an ion guide according to the present invention is
an ion guide in which an ion travels in an internal space from an inlet side toward an outlet side, in which
the ion guide includes a plurality of plate electrodes,
the plurality of plate electrodes is stacked at intervals in a stacking direction orthogonal to a traveling direction in which the ion travels,
at least two plate electrodes, in the plurality of plate electrodes, are inclined plate electrodes having an inclined surface inclined with respect to the traveling direction in a part facing the internal space,
each of the inclined plate electrodes has an inclination start point at which the inclined surface starts on an end surface on the inlet side, and
positions of the inclination start points in a direction orthogonal to both the traveling direction and the stacking direction are different for at least two of the inclined plate electrodes adjacent in the stacking direction.

An example of a mass spectrometer according to the present invention includes the ion guide described above.

The present description includes the disclosure of Japanese Patent Application No. 2022-110980 on which priority of the present application is based.

### Advantageous Effects of Invention

According to the ion guide and the mass spectrometer according to the present invention, it is possible to achieve both high ion uptake efficiency and high ion focusing efficiency.

### BRIEF DESCRIPTION OF DRAWINGS

FIG. 1 is a configuration diagram of a mass spectrometer of Example 1 of the present invention.

FIG. 2 is a configuration diagram of an ion guide of Example 1 (diagram viewed from the Z direction).

FIG. 3 is a configuration diagram of the ion guide of Example 1 (diagram viewed from the Z direction).

FIG. 4 is a configuration diagram of the ion guide of Example 1 (diagram viewed from the X direction).

FIG. 5 is an explanatory view of a plate electrode of Example 1 (diagram viewed from the X direction).

FIG. 6 is a configuration diagram of the ion guide of Example 1 (perspective view).

FIG. 7 is a configuration diagram of the ion guide of Example 1 (perspective view).

FIG. 8 is a configuration diagram of an ion guide of Example 2 (diagram viewed from the Z direction).

FIG. 9 is a configuration diagram of an ion guide of Example 3 (diagram viewed from the Z direction).

FIG. 10 is a configuration diagram of the ion guide of Example 3 (diagram viewed from the X direction).

FIG. 11 is a configuration diagram of an ion guide of Example 4 (diagram viewed from the Z direction).

FIG. 12 is a configuration diagram of an ion guide of Example 5 (diagram viewed from the Z direction).

FIG. 13 is a configuration diagram of an ion guide of Example 6 (diagram viewed from the Z direction).

FIG. 14 is a configuration diagram of an ion guide of Example 7 (diagram viewed from the Z direction).

FIG. 15 is a configuration diagram of an ion guide of Example 8 (diagram viewed from the Z direction).

FIG. 16 is a configuration diagram of an ion guide of Example 9 (diagram viewed from the Z direction).

FIG. 17 is a configuration diagram of an ion guide of Example 10 (diagram viewed from the Z direction).

FIG. 18 is a configuration diagram of an ion guide of Example 11 (diagram viewed from the Z direction).

FIG. 19 is an explanatory view of a plate electrode of Example 12 (diagram viewed from the X direction).

FIG. 20 is an explanatory view of a plate electrode of Example 13 (diagram viewed from the X direction).

FIG. 21 is an explanatory view of a plate electrode of Example 14 (perspective view).

FIG. 22 is a configuration diagram of an ion guide of Example 15 (diagram viewed from the Z direction).

FIG. 23 is a configuration diagram of an ion guide of Example 16 (diagram viewed from the Z direction).

FIG. 24 is a configuration diagram of an ion guide of Example 17 (diagram viewed from the Y direction).

### DESCRIPTION OF EMBODIMENTS

Embodiments of the present invention will be described below with reference to the accompanying drawings.

### (Example 1) (Upper and Lower Opposite Phase)

In Example 1, configurations of an ion guide and a mass spectrometer that apply radio-frequency voltages having opposite phases to each other between opposing plate electrodes will be described.

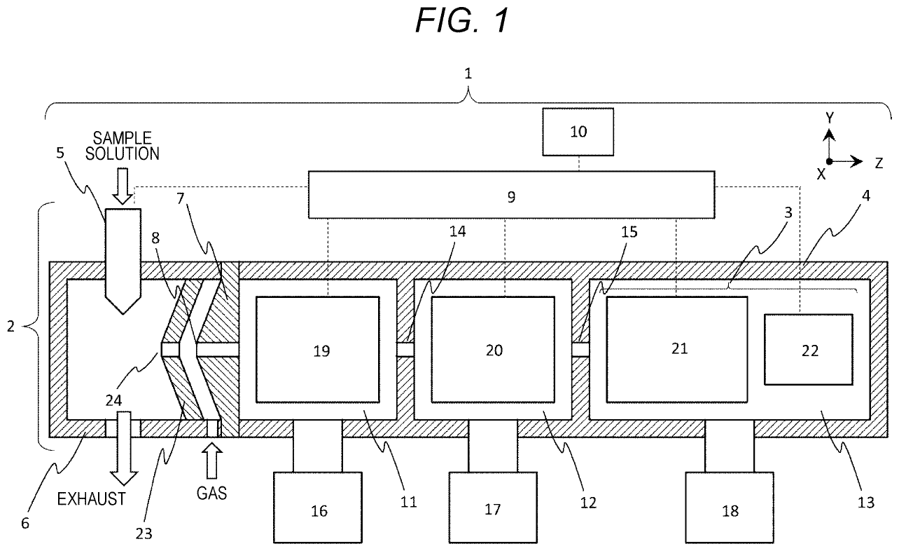

FIG. 1 illustrates the configuration of a mass spectrometer of the present example. A mass spectrometer 1 mainly includes an ion source 2 and a vacuum vessel 4 internally having a mass spectrometry unit 3. The ion source 2 mainly includes an ion generation unit 5 and an ion source chamber 6.

Ions generated by the ion source 2 are introduced into the vacuum vessel 4 from a hole 8 of an introduction electrode 7 and analyzed by the mass spectrometry unit 3. The ion source 2 and the mass spectrometry unit 3 are applied with various voltages by a power source 9. Timing of voltage application by the power source 9 and a voltage value are controlled by a control unit 10.

For the ion source 2, various ionization methods such as an electrospray method (ESI), an atmospheric pressure chemical ionization method (APCI), and an atmospheric pressure photoionization method (APPI) can be used. In a case of ionizing a sample solution, many droplets and the like are sprayed other than ions, and therefore the inside of the ion source chamber 6 is often evacuated to remove unnecessary droplets. For example, in the case of the ESI system, in order to reduce unnecessary droplets, it is common to promote vaporization of a solution and improve ionization efficiency by using both electrostatic spraying and gas spraying by high-voltage application by the power source 9.

Depending on the flow rate of the sample solution (generally in the range from the order of nL/min to the order of mL/min), the flow rate of gas is generally about 0.5 to 10 L/min, and an inert gas such as nitrogen or argon is generally used.

In order to further improve ionization efficiency, a method of heating, with a heating gas (up to about 800° C.) or the like, a space in which ions and droplets are sprayed is also common. The flow rate of the heating gas is generally about 0.5 to 50 L/min, and an inert gas such as nitrogen or argon is generally used.

As in FIG. 1, the inside of the vacuum vessel 4 may be divided into a plurality of vacuum chambers 11, 12, and 13. In this case, the vacuum chambers 11, 12, and 13 are connected by small-diameter holes 14 and 15. The holes 8 of the introduction electrode 7 and these holes 14 and 15 are paths of ions, and a member having each hole may be applied with a voltage. In this case, it is preferable to insulate a housing portion such as the vacuum vessel 4 via an insulator (not illustrated) or the like.

It is common that the diameters of the holes 8, 14, and 15 are about several mm or less (e.g., 10 mm or less). It is common that the vacuum chambers 11, 12, and 13 are evacuated by vacuum pumps 16, 17, and 18, respectively, and held at about several hundred Pa to several thousand Pa (e.g., 100 to 10000 Pa), about several Pa (e.g., 1 to 10 Pa), and about 0.1 Pa or less, respectively.

The mass spectrometer 1 includes an ion guide 19. The ion guide 19 is installed in the vacuum chamber 11. The vacuum chamber 12 includes an ion transport unit 20 that transmits ions while focusing them similarly to the ion guide 19. A multipole ion guide, an electrostatic lens, an ion funnel, or the like can be used for the ion transport unit 20.

The ion guide 19 and the ion transport unit 20 are applied, from the power source 9, with a radio-frequency voltage, a direct-current voltage, an alternating-current voltage, or a voltage in which these are combined. The number of vacuum chambers may be larger or smaller than 3 (FIG. 1). For example, there is a case where another vacuum chamber is provided between the vacuum chamber 11 and the vacuum chamber 12 and held at about several hundred Pa (e.g., 100 to 1000 Pa), and another ion transport unit or the like is disposed.

The mass spectrometry unit 3 includes an ion analysis unit 21 and a detector 22. For the ion analysis unit 21, which separates and dissociates ions, an ion trap, a quadrupole filter electrode, a collision cell, a time-of-flight mass spectrometer (TOF), or a configuration in which these are combined can be used. Ions having passed through the ion analysis unit 21 are detected by the detector 22. An electron multiplier tube, a multichannel plate (MCP), or the like can be used for the detector 22.

Ions detected by the detector 22 are converted into electric signals and the like. Information such as mass and intensity of the ions can be analyzed in detail by the control unit 10. The control unit 10 includes an input/output unit and a memory for receiving an instruction input from a user and controlling voltage and the like. The control unit 10 also includes software necessary for power source operation. As the voltage supplied from the power source 9 to the mass spectrometry unit 3, a radio-frequency voltage, a direct-current voltage, an alternating-current voltage, or a voltage in which these are combined, or the like can be used.

In the configuration of FIG. 1, a counter electrode 23 is disposed in front of the introduction electrode 7. By allowing a gas to flow between the introduction electrode 7 and the counter electrode 23 and spraying the gas from a hole 24 of the counter electrode 23, it is possible to suppress noise components such as excessive droplets sprayed by the ion source 2 from entering the hole 8 of the introduction electrode 7. The flow rate of the gas is generally about 0.5 to 50 L/min, and an inert gas such as nitrogen or argon is generally used. The diameter of the hole 24 of the counter electrode 23 is generally several mm or less (e.g., 10 mm or less). The applied voltage is generally about ±several kV at the maximum (e.g., amplitude is 10 kV or less).

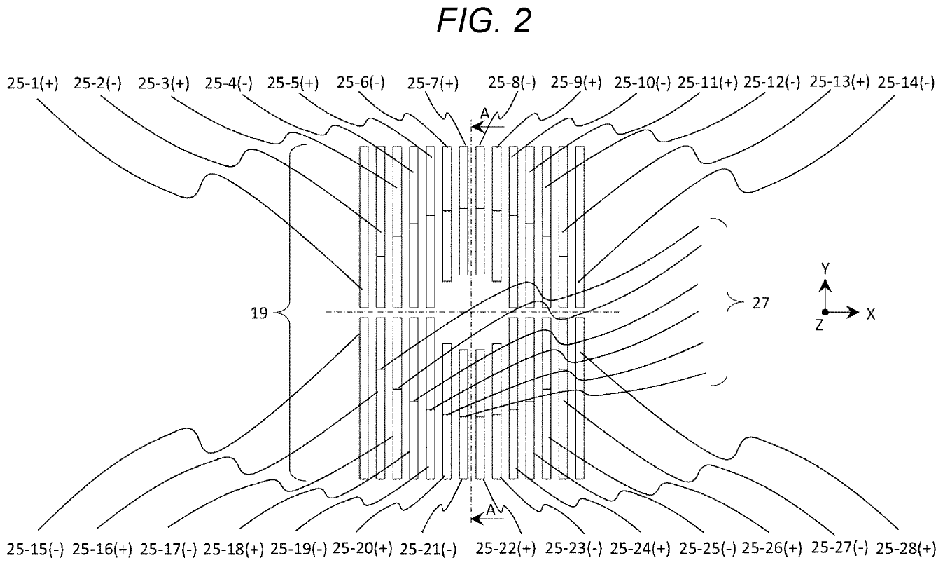

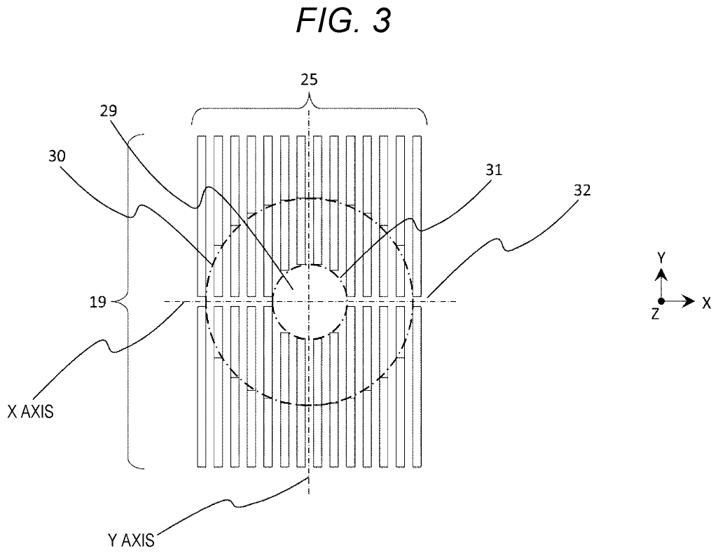

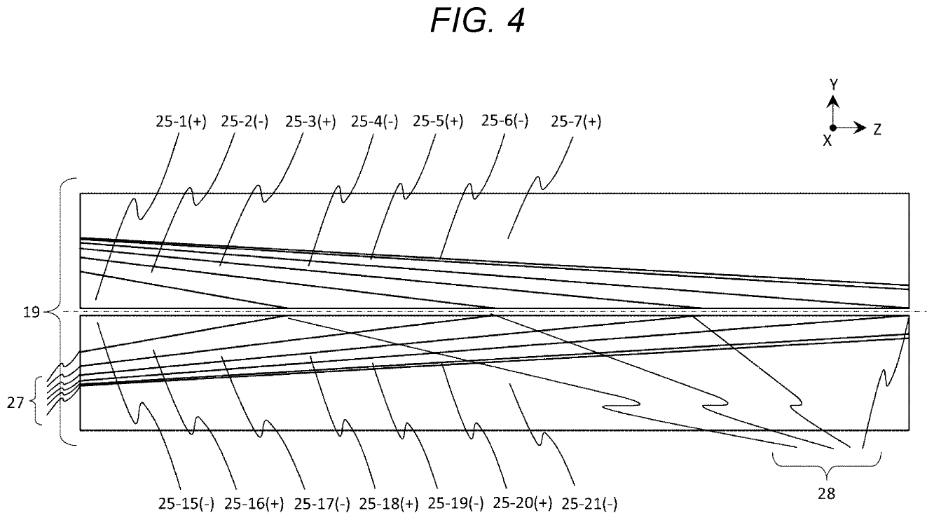

The ion guide 19 of the present example will be described in detail with reference to FIGS. 2 to 7. FIGS. 2 and 3 are diagrams of the ion guide 19 as viewed from the ion inlet direction (left side in FIG. 1). FIG. 4 is a cross-sectional view taken along line A-A in FIG. 2. FIGS. 2 and 3 are diagrams illustrating the same configuration. In order to prevent the drawings from being complicated, symbols illustrated in FIGS. 2 and 3 are prevented from overlapping as much as possible.

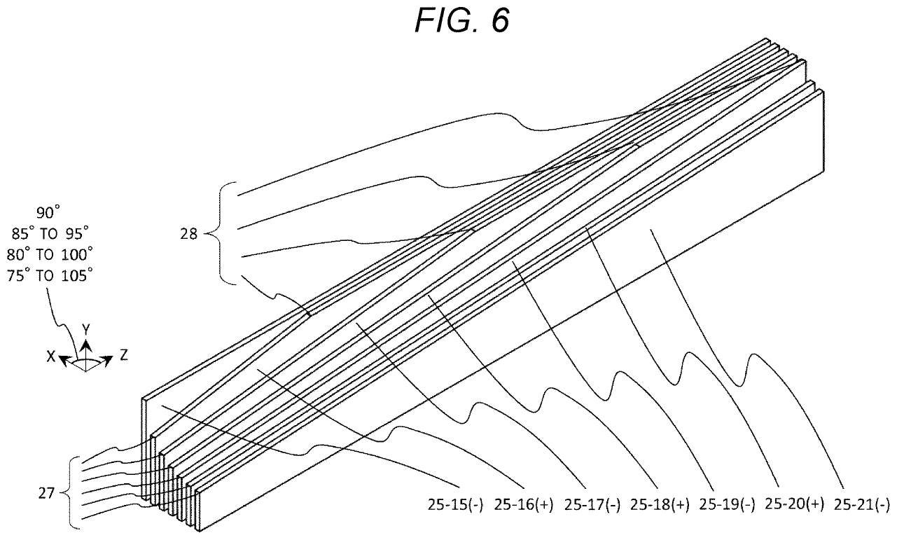

The ion guide 19 of the present example includes a plurality of plate electrodes 25. The plurality of plate electrodes 25 are stacked at intervals in the stacking direction (X direction) orthogonal to the traveling direction (Z direction) of ions. Although the orthogonality in the present example is ideally 90 degrees, it is not strictly necessary to be 90 degrees in consideration of the accuracy of components and assembly. For example, from the viewpoint of efficiently transporting ions, as illustrated in FIG. 6, the “stacking direction (X direction) orthogonal to the traveling direction (Z direction) of ions” is preferably a direction forming an angle within a range of 75 degrees to 105 degrees with respect to the Z direction, more preferably a direction forming an angle within a range of 80 degrees to 100 degrees with respect to the Z direction, and still more preferably a direction forming an angle within a range of 85 degrees to 95 degrees with respect to the Z direction.

Both the thickness of the plate electrode 25 and the stack interval between the plate electrodes 25 are preferably about several mm or less (e.g., 10 mm or less). The ion guide 19 of the present example has a total of the 28 plate electrode 25 of 25-1 to 25-28.

An internal space 29 of the ion guide 19 is formed by the plate electrodes 25 that are stacked. Ions travel from the inlet side (Z direction negative side) toward the outlet side (Z direction positive side) of the ion guide 19, and travel in the internal space 29.

The definition of the “traveling direction of ions” representing the Z direction can be appropriately determined by those skilled in the art. For example, if ions (in particular, ions reaching the detector 22. The trajectory may be statistically calculated) travel in the same direction immediately before entering the internal space 29 of the ion guide 19, while traveling in the internal space 29, and immediately after escaping from the internal space 29, the direction becomes the traveling direction of the ions.

On the other hand, if the traveling directions of the ions are different (not strictly parallel) immediately before entering the internal space 29, while traveling in the internal space 29, and immediately after escaping from the internal space 29, any of them can be defined as the traveling direction of the ions (whichever is defined as the traveling direction, the effect of the present example can be obtained at least partially).

Alternatively, for example, a direction connecting the center of the hole 8 of the introduction electrode 7 and the center of the hole 14 may be defined as the traveling direction of ions.

The plate electrodes 25-1 to 25-28 are applied, by the power source 9, with an alternating-current voltage (e.g., radio-frequency voltage) and a direct-current voltage. In particular, the power source 9 can apply radio-frequency voltages having opposite phases to each other between the plate electrodes 25 adjacent in the stacking direction. That is, radio-frequency voltages of the same phase are applied every other plate electrode, and radio-frequency voltages of opposite phases are applied to adjacent plate electrodes therebetween. In FIG. 2, for convenience, the phases are represented by plus (+) and minus (−).

The ion guide 19 of the present example has a feature that radio-frequency voltages of opposite phases are applied between the plate electrodes opposing up and down (Y direction). Note that (+) and (−) may be reversed from the example of the drawing.

The radio-frequency voltage is set to have a frequency of about a maximum several MHZ (e.g., 10 MHz or less) and a voltage amplitude of about a maximum several kV (e.g., 10 kV or less). The direct-current voltage is set to a maximum of about several hundred V (e.g., 1 kV or less).

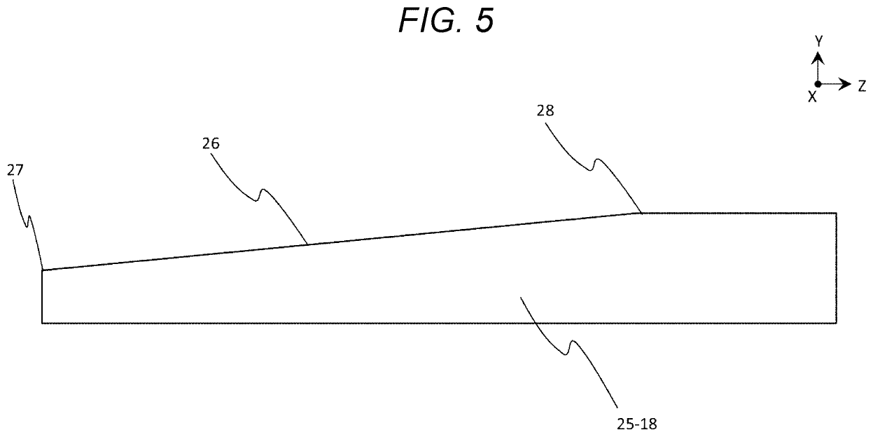

As another feature of the present example, as illustrated in FIG. 5, the plate electrodes 25 includes those having an inclined surface 26 inclined with respect to the traveling direction (Z direction) of ions in a part facing the internal space 29. Among the plate electrodes 25, those having the inclined surface 26 (the plate electrodes 25-2 to 25-13 and 25-16 to 25-27 in the present example) are particularly called “inclined plate electrodes”. At least two (24 plate electrodes in the present example) of the plate electrodes 25 are such inclined plate electrodes.

FIG. 5 illustrates the shape of the plate electrode 25-18 as an example of the inclined plate electrode. The inclined surface 26 is defined by an inclination start point 27 on the inlet side and an inclination end point 28 in the Z direction. That is, each of the inclined plate electrodes has the inclination start point 27 at which the inclined surface 26 starts on the end surface on the inlet side (Z direction negative side). Each of the inclined plate electrodes has the inclination end point 28 at which the inclined surface 26 ends in a part facing the internal space 29.

The plate electrode 25 can be produced by machining a metal plate by milling, punching, laser machining, wire cut electrical discharge machining, or the like.

As a feature of the ion guide 19 of the present example, there is a place where the position (i.e., the Y coordinate) of the inclination start point 27 on the inlet side in the direction (Y direction) orthogonal to both the traveling direction (Z direction) of ions and the stacking direction (X direction) of the plate electrodes 25 is different between adjacent plate electrodes (FIG. 2 illustrates only ¼ parts of the lower left of the inclination start point 27, for convenience). That is, for at least two inclined plate electrodes adjacent in the stacking direction of the plate electrodes 25, the positions of the inclination start points 27 in the direction (Y direction) orthogonal to both the traveling direction of ions and the stacking direction of the plate electrodes 25 are different.

As another feature of the ion guide 19 of the present example, there is a place where the inclination end points 28 in the Z direction are also different between adjacent plate electrodes (FIG. 4 illustrate the inclination start point 27 and the inclination end point 28 only for parts corresponding to the ¼ part of the lower left of FIG. 2, for convenience). That is, for at least two inclined plate electrodes adjacent in the stacking direction of the plate electrodes 25, the positions (i.e., Z coordinate) of the inclination end points 28 in the traveling direction of ions are different. In the present example, the inclination start point 27 is closer to the X axis and the inclination end point 28 is closer to the inlet side as the electrode is more outward in the X direction.

An inscribed shape 30 and an inscribed shape 31 are formed by connecting inscribed points of respective electrodes on the inlet side and the outlet side of the internal space 29 by the plurality of plate electrodes 25. In the present example, the inscribed shape 30 on the inlet side and the inscribed shape 31 on the outlet side are approximate circles (i.e., the shape is approximate to a circle, and may be a perfect circle).

The positional relationship between the inclination start point 27 and the inclination end point 28 of each inclined plate electrode is not limited to that illustrated in the present example, and can be discretionarily modified. Here, when the Y direction position of the inclination start point 27 of each inclined plate electrode changes in accordance with a monotonous change function in a broad sense from the outside to the inside of the stacking direction of the plate electrodes 25, the inscribed shape 30 on the inlet side can be smoothly formed. For example, in the present example, the Y direction position of the inclination start point 27 monotonously increases from the plate electrode 25-1 toward the plate electrode 25-7.

The mathematical definition of “monotonous change in a broad sense” will be apparent to those skilled in the art, but includes, for example, monotonous increase in a broad sense and monotonous decrease in a broad sense. The monotonous increase in a broad sense means increasing or not changing (i.e., not decreasing), and the monotonous decrease in a broad sense means decreasing or not changing (i.e., not increasing).

In the ion guide 19 of the present example, an interval 32 is provided between the plate electrodes opposing up and down (Y direction). Therefore, the total of 28 (the number of plate electrodes effectively contributing to formation of the multipolar electric field) plate electrodes 25 are inscribed in the inscribed shape 30 (approximate circle) on the inlet side. The total of 12 (25-5 to 25-10 and 25-19 to 25-24) plate electrodes 25 are inscribed in the inscribed shape 31 (approximate circle) on the outlet side.

By the application of the radio-frequency voltage by the power source 9, the multipolar electric field is formed in the internal space 29. In particular, a 28-pole electric field is formed on the inlet side of the internal space 29, and a 12-pole electric field is formed on the outlet side. Due to such a multipolar electric field, ions are efficiently transported.

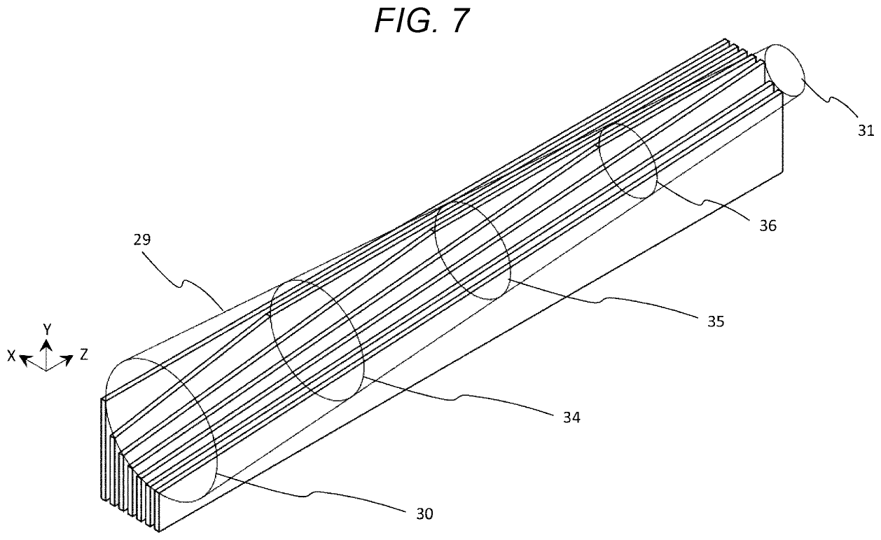

Perspective views of the ¼ parts on the lower left side of FIGS. 2 and 3 are illustrated in FIGS. 6 and 7. FIGS. 6 and 7 are diagrams illustrating the same configuration. In order to prevent the drawings from being complicated, symbols illustrated in FIGS. 6 and 7 are prevented from overlapping as much as possible.

The positions of the inclination start point 27 on the inlet side and the inclination end point 28 in the Z direction are different and shifted between adjacent plate electrodes. Accordingly, it is possible to form the internal space 29 in which the inscribed shape gradually decreases from the inscribed shape 30 on the inlet side toward the inscribed shape 31 on the outlet side and is approximated to a tapered shape. A total of 24 (25-2 to 25-13 and 25-16 to 25-27), 20 (25-3 to 25-12 and 25-17 to 25-26), and 16 (25-4 to 25-11 and 25-18 to 25-25) plate electrodes 25 are inscribed in the inscribed shapes 34, 35, and 36 (approximate circles), respectively, at the three inclination end points 28 in the Z direction.

That is, the internal space 29 is gradually narrowed along the traveling direction of ions by the inclined surface 26 of the plate electrode 25. The interval between the plate electrodes opposing up and down (Y direction) is narrowed to the interval 32. Thereby, the electric fields of a total of four electrodes outside the plate electrodes are blocked, and therefore the number of poles of the electric field decreases by 4 at the inclination end point 28 in the Z direction. That is, the number of plate electrodes effectively contributing to formation of the multipolar electric field and the number of poles of the multipolar electric field are smaller on the outlet side than on the inlet side. As a result, from the inlet side toward the outlet side of the ion guide 19, the number of the poles can be decreased stepwise from 28-pole electric field→24-pole electric field→20-pole electric field→16-pole electric field→12-pole electric field. The area of the inscribed shape of the plate electrodes forming the multipolar electric field is smaller on the outlet side than on the inlet side. Therefore, the ion focusing efficiency can be further enhanced.

With this configuration, on the inlet side, the ion uptake efficiency is increased by increasing the number of the poles. The ion focusing efficiency (in general, the smaller the number of poles is, the higher the ion focusing efficiency is) is increased by gradually decreasing the number of poles, whereby the ion transmittance in the ion guide 19 can be improved. Note that the plate electrodes 25 may include those not inclined plate electrodes (i.e., those having no inclined surface 26. For example, the plate electrodes 25-1, 25-14, 25-15, 25-18, and the like).

The configurations of the ion guide 19 and the mass spectrometer 1 according to Example 1 described above can achieve both high ion uptake efficiency and high ion focusing efficiency.

The ion guide 19 can be disposed in another vacuum chamber such as the vacuum chamber 12 other than the vacuum chamber 11 described above. For example, in place of the ion transport unit 20, an ion guide having an identical or similar configuration to that of the ion guide 19 may be used.

### (Example 2) (Upper and Lower Same Phase)

In Example 2, a configuration of an ion guide to which radio-frequency voltage of the same phase are applied between opposing plate electrodes will be described.

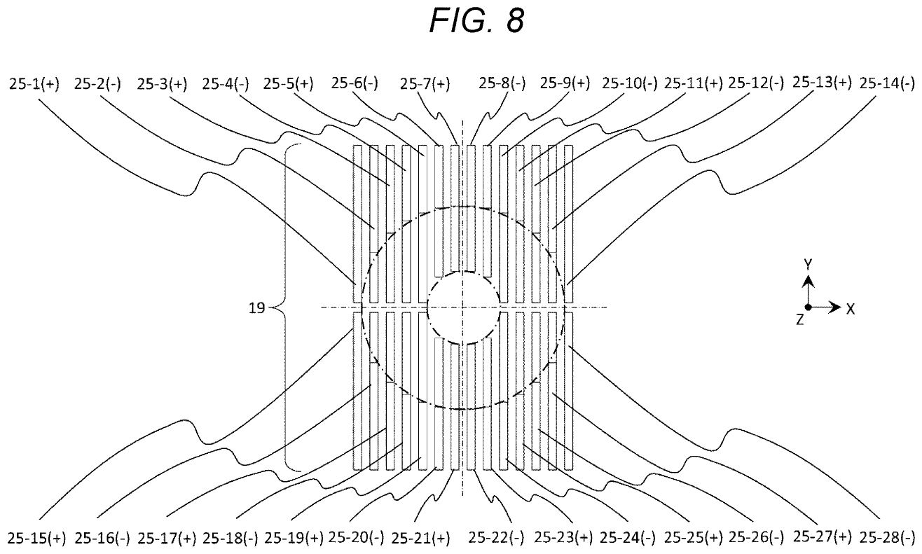

The ion guide 19 of the present example will be described in detail with reference to FIG. 8. For convenience, description of parts common to those of Example 1 may be omitted. The present example has a feature that radio-frequency voltages of the same phase are applied between the plate electrodes opposing up and down (Y direction). Note that (+) and (−) may be reversed from the example of the drawing.

When radio-frequency voltages of opposite phases are applied between the plate electrodes 25 opposing each other up and down as in Example 1, the electric field of the internal space 29 may be disturbed by the influence of a multipolar electric field (quadrupole electric field) formed between the plate electrode 25 constituting the internal space 29 and the plate electrode 25 outside the internal space 29 in the vicinity of the position where the number of poles decreases in the Z direction. On the other hand, in the configuration in which radio-frequency voltages having the same phase are applied between the plate electrodes 25 opposing each other up and down as in the present example, there is an advantage that disturbance of the electric field can be reduced because the multipolar electric field is not formed outside.

In the configuration of FIG. 8, the plate electrode 25-1 and the plate electrode 25-15 have the same phase (same potential) with each other, and the plate electrode 25-14 and the plate electrode 25-28 have the same phase (same potential) with each other, and are each regarded as one electrode. Thus, the number of poles is different even in the configuration of the same number of electrodes as in FIG. 2 and the like. For example, from the inlet side toward the outlet side of the ion guide 19, the number of poles is decreased by 2 compared to Example 1, 26-pole electric field→22-pole electric field→18-pole electric field→14-pole electric field→10-pole electric field.

The same effects as those of Example 1 can be obtained by the configuration of Example 2 described above. In particular, this is effective in reduction of electric field disturbance in a portion where the number of poles is reduced.

### (Example 3) (Upper and Lower Single Plate)

In Example 3, a configuration of an ion guide to which radio-frequency voltage of the same phase are applied between opposing plate electrodes, the configuration including those having opposing plate electrodes being formed of an integrated component will be described.

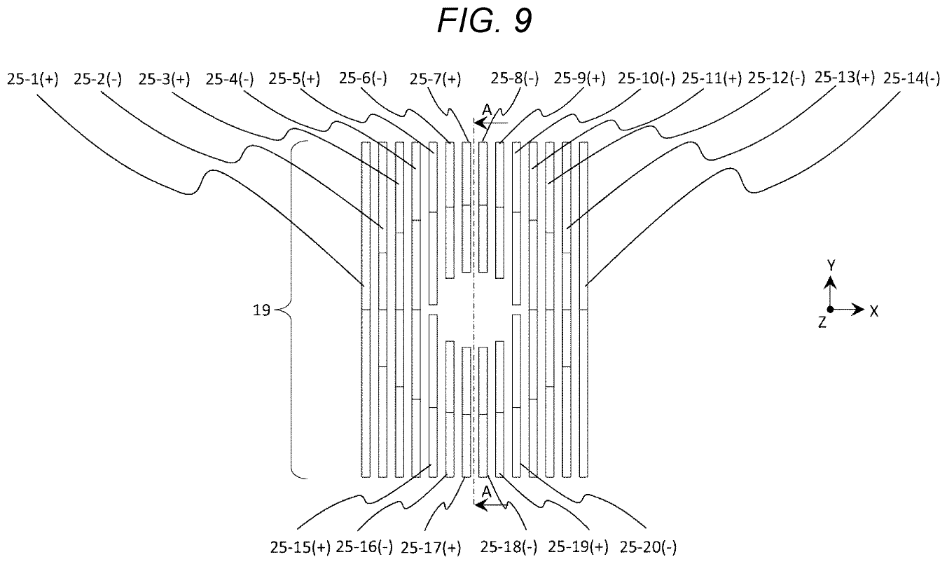

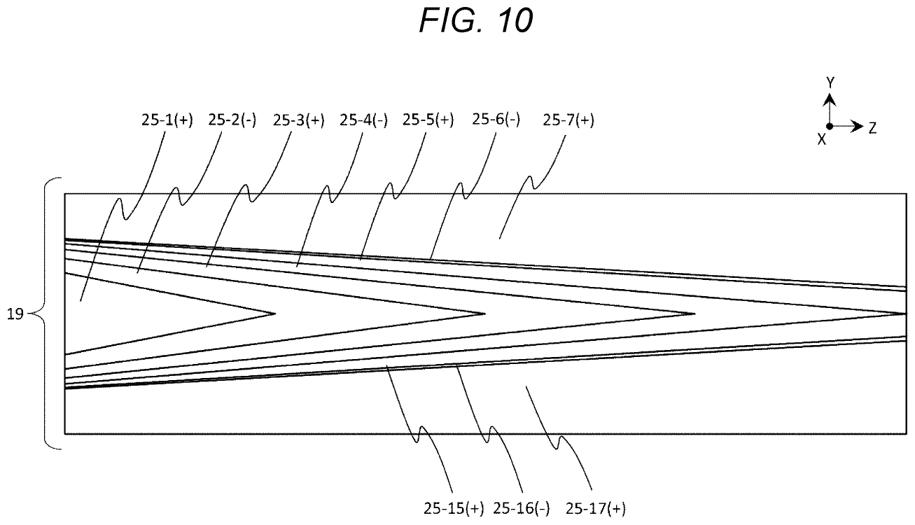

The ion guide 19 of the present example will be described in detail with reference to FIGS. 9 and 10. For convenience, description of parts common to those of the above-described examples may be omitted. The present example has features that radio-frequency voltages of the same phase are applied between the plate electrodes opposing up and down (Y direction), and some of the opposing electrodes are formed of an integrated component (25-1 to 25-4 and 25-11 to 25-14). Note that (+) and (−) may be reversed from the example of the drawing.

In the present example, the number of the plate electrodes 25 is a total of 20 (25-1 to 25-20). The number of components can be reduced as compared with Example 2, and substantially the same effects as those of Example 2 can be obtained.

The same effects as those of Examples 1 and 2 can be obtained by the configuration of Example 3 described above. In particular, this is effective in cost reduction due to a decrease in the number of components.

### (Example 4) (Inscribed Shape is Square)

In Example 4, a configuration in which the inscribed shape of an ion guide is a square will be described.

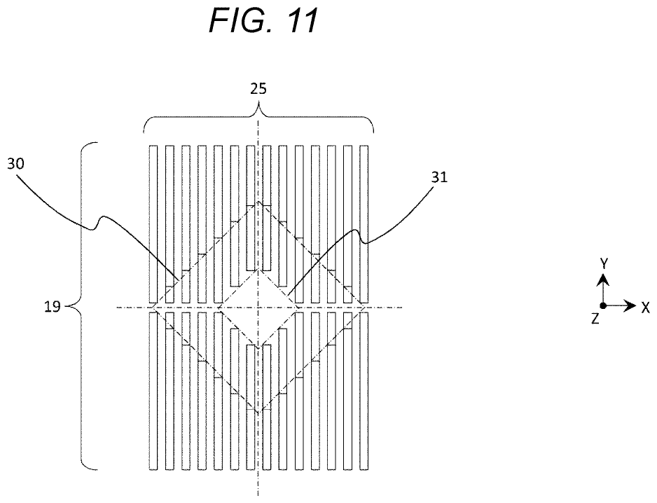

The ion guide 19 of the present example will be described in detail with reference to FIG. 11. For convenience, description of parts common to those of the above-described examples may be omitted. The present example has a feature that the inscribed shapes 30 and 31 are approximated to a square.

In the configuration (e.g., FIG. 3) in which the inscribed shapes 30 and 31 are approximate circles s as described in each of the above-described examples, the distance in the Y direction between adjacent pairs of plate electrodes of the electrode surface constituting the internal space 29 (more strictly, the edge constituting the inscribed shape of each of the plate electrodes 25; it is expressed as points constituting the inscribed shapes 30 and 31, for example) tends to be wider as an electrode pair is present on an outer side in the X direction.

In the adjacent plate electrode pair, when the distance between the electrode surfaces forming an electric field is wider (e.g., on the more outside in the X direction), the electric field becomes relatively weak as compared with a part where the distance between the electrode surfaces is narrow (e.g., on the more inside in the X direction). Therefore, the overall multipolar electric field has a distorted shape. On the contrary, if the inscribed shapes 30 and 31 are squares as in FIG. 11, the distance between the electrode surfaces of the adjacent plate electrode pair can be made substantially constant. Therefore, a multipolar electric field having high symmetry can be formed.

The same effects as those of Example 1 can be obtained by the configuration of Example 4 described above. In particular, this is effective in formation of a multipolar electric field having high symmetry.

Note that, In Example 4, the inscribed shapes 30 and 31 are square. Alternatively, as a modification, the inscribed shapes may be rhomboids, general quadrangles, or other polygons.

### (Example 5) (Inscribed Shape is Ellipse)

In Example 5, a configuration in which the inscribed shape of an ion guide is an ellipse will be described.

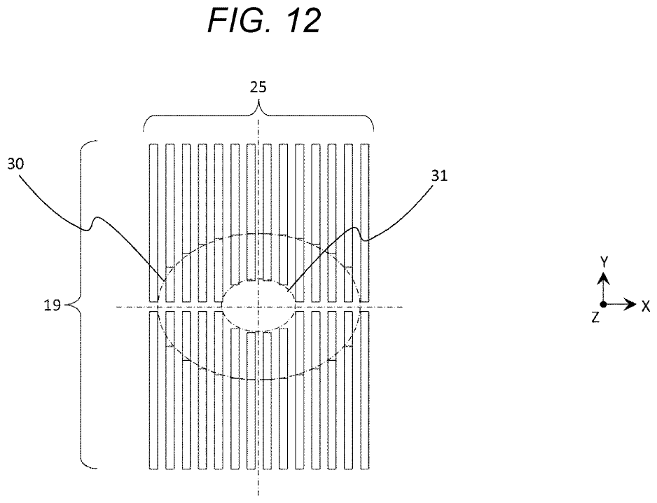

The ion guide 19 of the present example will be described in detail with reference to FIG. 12. For convenience, description of parts common to those of the above-described examples may be omitted. The present example has a feature that the inscribed shapes 30 and 31 are approximate to an ellipse. Similarly to Example 4, the distance (Y direction) of the electrode surface where an electric field is formed by adjacent plate electrodes can be narrowed even in an electrode present on more outside in the X direction. Therefore, the electric field can be prevented from being locally weakened.

The same effects as those of Example 1 can be obtained by the configuration of Example 5 described above. In particular, it has an effect of preventing the electric field from being locally weakened.

### (Example 6) (Eccentricity)

In Example 6, a configuration in which the barycenter positions on the inlet side and the outlet side of an ion guide are eccentric will be described.

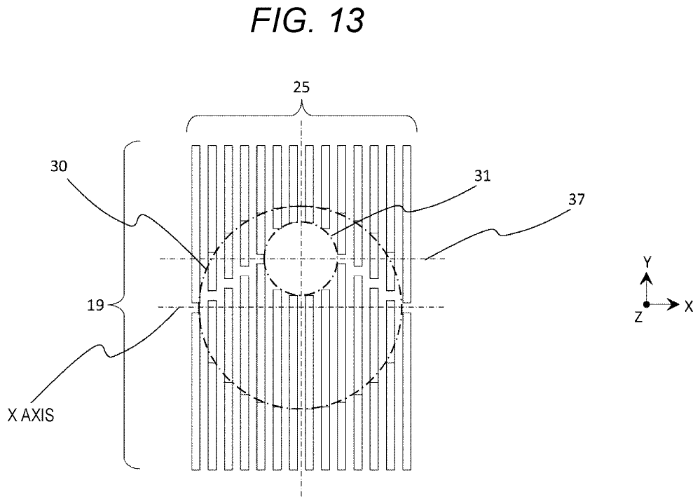

The ion guide 19 of the present example will be described in detail with reference to FIG. 13. For convenience, description of parts common to those of the above-described examples may be omitted. The present example has a feature that the barycenter of the inscribed shape is eccentric between the inscribed shape 30 on the inlet side and the inscribed shape 31 on the outlet side. In the example of FIG. 13, the barycenter of the inscribed shape 31 on the outlet side is eccentric to an outlet barycenter position 37 (Y direction positive side relative to the X axis) with respect to the barycenter position (on the X axis) of the inscribed shape 30 on the inlet side.

Note that in the present example, since both the inscribed shape 30 and the inscribed shape 31 are circular, the barycenter is the center of the circle.

In the present example, the Z axis (traveling direction of ions) can be, for example, a direction in which ions have traveled immediately before entering the internal space.

In general, when droplets other than ions flow into the vacuum due to insufficient vaporization in the ion source 2 or the like, not only a noise factor but also deterioration of the detector 22 and contamination of the ion analysis unit 21 are caused. Therefore, it is desirable to remove the droplets on the front stage side as much as possible.

Droplets other than ions are not affected by an electric field, and therefore tend to travel straight as they are when they flow into vacuum by an airflow. Therefore, when the barycenter positions of the inscribed shape 30 on the inlet side and the inscribed shape 31 on the outlet side of the ion guide 19 are eccentric as in the present example, contaminants such as droplets travel straight, and only ions affected by the electric field are deflected toward the outlet barycenter position 37. By aligning the outlet barycenter position 37 with the center position of the hole 14 (see FIG. 1) in the subsequent stage, it is possible to remove droplets and introduce only ions into the ion transport unit 20 on a further subsequent stage. In this manner, it is possible to prevent deterioration of the detector 22, contamination of the ion analysis unit 21, and the like.

The same effects as those of Example 1 can be obtained by the configuration of Example 6 described above. In particular, this is effective in achievement of a highly robust mass spectrometer.

### (Example 7) (Interval Positions Between Upper and Lower Electrodes are Shifted)

In Example 7, a configuration of an ion guide in which interval positions between opposing plate electrodes are shifted in the Y direction will be described.

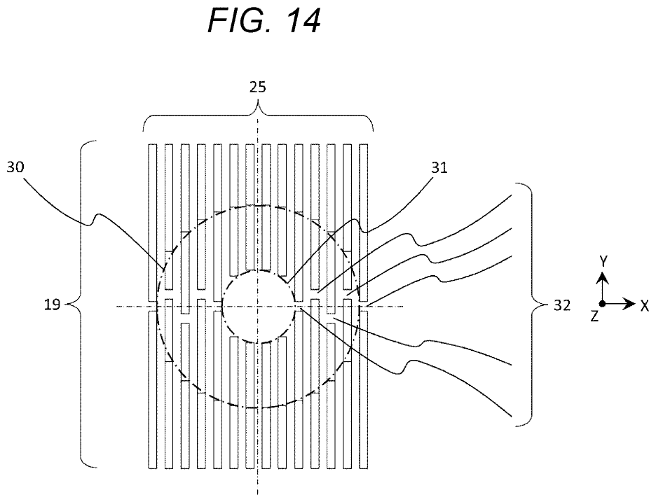

The ion guide 19 of the present example will be described in detail with reference to FIG. 14. For convenience, description of parts common to those of Example 1 may be omitted. The present example has a feature that the position of the interval 32 between the plate electrodes opposing up and down (Y direction) is shifted in the Y direction between the adjacent electrodes.

Since the Y direction position of the interval 32 between the electrodes is shifted, even in a configuration in which the radio-frequency voltages of opposite phases are applied to the plate electrodes opposing up and down as in Example 1, it is possible to reduce the influence of the multipolar electric field (quadrupole electric field) formed between the plate electrodes on the outside in the vicinity of the position where the number of poles decreases.

The same effects as those of Example 1 can be obtained by the configuration of Example 7 described above. In particular, this is effective in reduction of electric field disturbance in a portion where the number of poles is reduced.

### (Example 8) (Two Stacking Directions)

In Example 8, a configuration of an ion guide having a plurality of stacking directions of plate electrodes will be described.

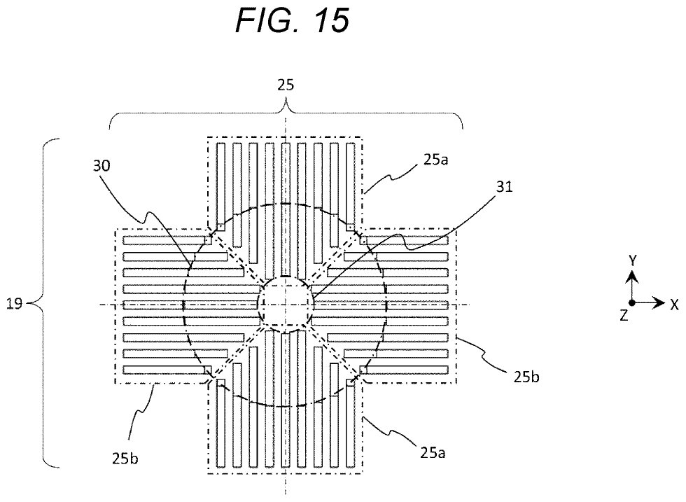

The ion guide 19 of the present example will be described in detail with reference to FIG. 15. For convenience, description of parts common to those of Example 1 may be omitted.

In the ion guide 19 of the present example, the basic configuration in which the plurality of plate electrodes 25 are stacked at intervals in the stacking direction orthogonal to the traveling direction (Z direction) of ions is the same as that of Example 1.

As a difference from Example 1, in the present example, there are two stacking directions (the X direction and the Y direction in the example of FIG. 15). That is, a plate electrode group 25a stacked in the X direction and a plate electrode group 25b stacked in the Y direction are included.

The stacking direction in two directions, similarly to Example 4 (FIG. 11), can further reduce the change in an electrode surface distance between adjacent plate electrodes, and can form a multipolar electric field having high symmetry.

The same effects as those of Example 1 can be obtained by the configuration of Example 8 described above. In particular, this is effective in formation of a multipolar electric field having high symmetry.

### (Example 9) (Upper and Lower Electrodes are Shifted)

In Example 9, a configuration of an ion guide in which positions of upper and lower plate electrodes are shifted will be described.

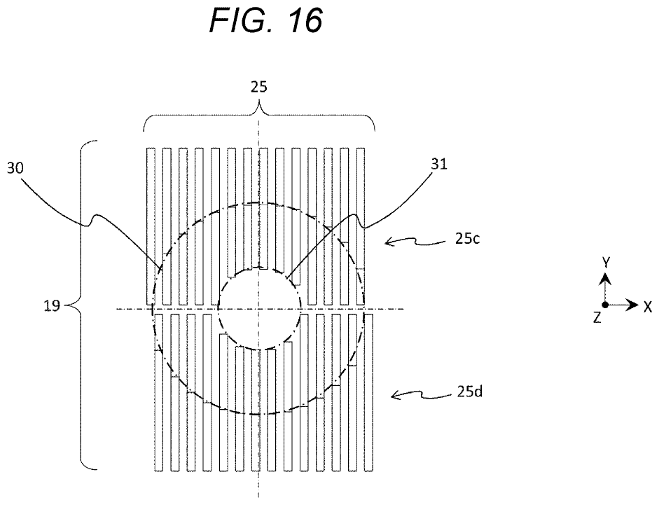

The ion guide 19 of the present example will be described in detail with reference to FIG. 16. For convenience, description of parts common to those of Example 1 may be omitted. The present example has a feature that the X direction position of the plate electrode 25 is shifted between the upper side and the lower side (Y direction). For example, the X direction position of each plate electrode is different between a plate electrode group 25c on the Y direction positive side and a plate electrode group 25d on the Y direction negative side.

In this configuration, similarly to Example 7 (FIG. 14), even in a configuration in which the radio-frequency voltages of opposite phases are applied to the plate electrodes opposing up and down, it is possible to reduce the influence of the multipolar electric field (quadrupole electric field) formed between the electrodes on the outside in the vicinity of the position where the number of poles decreases.

The same effects as those of Example 1 can be obtained by the configuration of Example 9 described above. In particular, this is effective in reduction of electric field disturbance in a portion where the number of poles is reduced.

### (Example 10) (Different Plate Thickness)

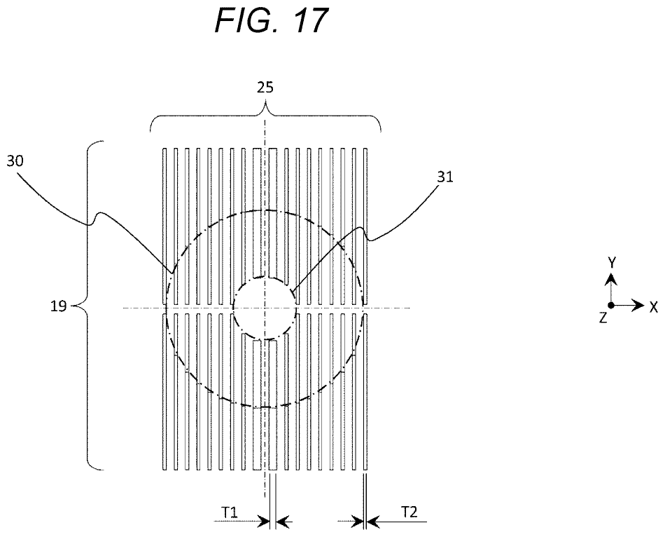

In Example 10, a configuration of an ion guide including plate electrodes of different thicknesses will be described. The ion guide 19 of the present example will be described in detail with reference to FIG. 17. For convenience, description of parts common to those of the above-described examples may be omitted.

The present example has a feature that the thickness of the plate electrodes 25 is different between the inside and the outside in the X direction. In the example of FIG. 17, a thickness T2 of the plate electrode 25 on the outside is thinner than a thickness T1 of the plate electrode 25 on the inside.

This configuration can make the stack denser toward the outside. Therefore, the electrode surface distance (Y direction distance) by which the electric field is formed between adjacent plate electrodes can be narrowed even in a plate electrode more outside in the X direction similarly to Example 5, and the electric field can be prevented from being locally weakened.

Note that it is sufficient that even only one set has a combination of the thicknesses of the plate electrodes 25 different between the inside and the outside. The thickness may be decreased stepwise or monotonically from the inside toward the outside, or the plate electrodes 25 all having different thicknesses may be used.

The same effects as those of Example 1 can be obtained by the configuration of Example 10 described above. In particular, it has an effect of preventing the electric field from being locally weakened.

### (Example 11) (Different Stacking Gaps)

In Example 11, a configuration of an ion guide having different stacking intervals of plate electrodes will be described.

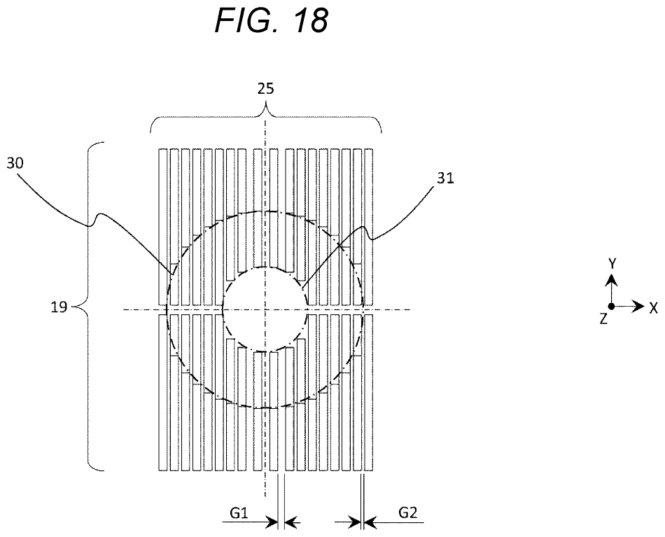

The ion guide 19 of the present example will be described in detail with reference to FIG. 18. For convenience, description of parts common to those of the above-described examples may be omitted. The present example has a feature that the stacking interval of the plate electrodes 25 is different between the inside and the outside in the X direction. In the example of FIG. 18, a stack interval G2 of the plate electrode 25 on the outside is narrower than a stack interval G1 of the plate electrode 25 on the inside. In particular, the stack becomes denser toward the outside.

In this manner, similarly to Example 10, in an electrode on more outside in the X direction, the distance between electrode surfaces forming the electric field between adjacent plate electrodes can be narrowed. Therefore, the electric field can be prevented from being locally weakened.

Note that it is sufficient that even only one set has a combination of the stacking intervals of the plate electrodes 25 different between the inside and the outside. The stack interval may be decreased stepwise or monotonically from the inside toward the outside. Alternatively, the plate electrodes 25 all having different intervals may be stacked. It may be more effective to combine the configuration of the present example with the configuration in which the plate thicknesses of the plate electrodes 25 of Example 10 are not constant (Example 10 and FIG. 17).

The same effects as those of Example 1 can be obtained by the configuration of Example 11 described above. In particular, it has an effect of preventing the electric field from being locally weakened.

### (Example 12) (Inclined Surface is Curved Surface)

In Example 12, a configuration of an ion guide in which the inclined surface of the plate electrode is a curved surface will be described.

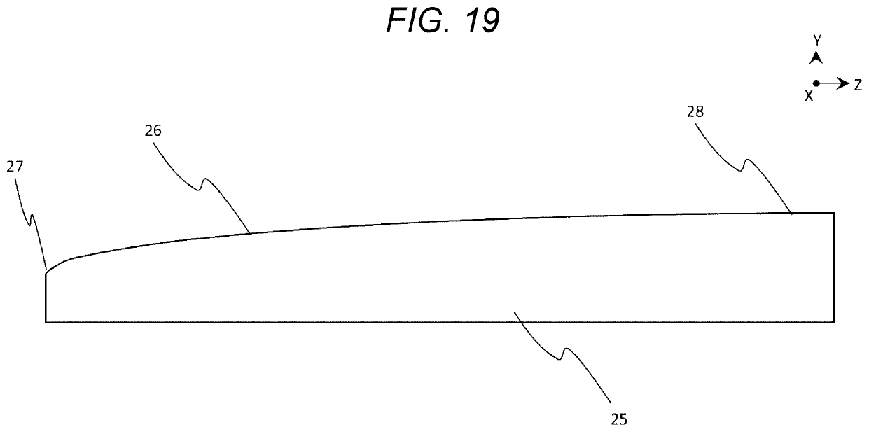

The ion guide 19 of the present example will be described in detail with reference to FIG. 19. For convenience, description of parts common to those of the above-described examples may be omitted. In each of the above-described examples, the inclined surface 26 of the plate electrode 25 has a planar shape. In contrast, in the present example, the inclined surface 26 has a curved surface shape (e.g., the cross section of the inclined surface 26 viewed from the direction illustrated in FIG. 19 has a curved line shape).

This configuration can ease the change in the multipolar electric field in the vicinity of the position where the number of poles decreases, and therefore can reduce disturbance of the electric field in this vicinity.

Note that the shape of the inclined surface 26 is not limited to the above-described planar shape and the curved surface shape of the present example. The shape of the inclined surface 26 may partially include a planar part perpendicular or parallel to the traveling direction (Z direction) of ions, may be a composite shape including an inclined plane, a curved surface, and a plane perpendicular or parallel to the Z direction, or may be a shape changing stepwise, and various shapes can be used.

The same effects as those of Example 1 can be obtained by the configuration of Example 12 described above. In particular, this configuration has an effect of reducing local electric field disturbance.

### (Example 13) (Reduction in Surface Area of Plate Electrode)

In Example 13, a configuration of an ion guide that can reduce the surface area of the plate electrode will be described.

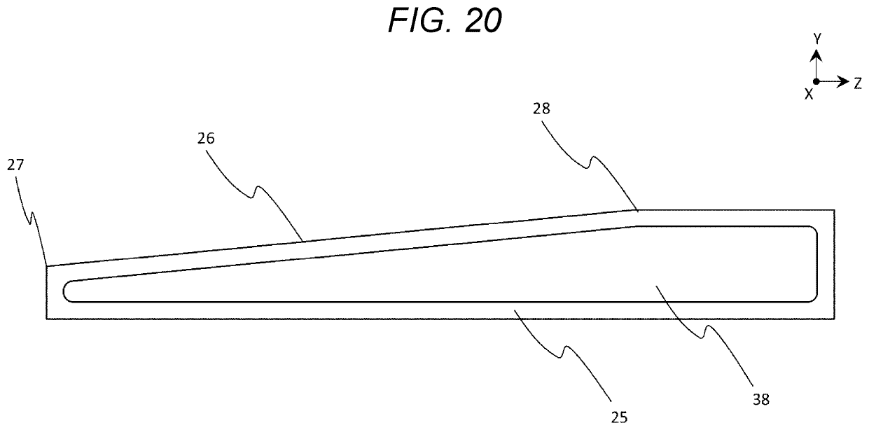

The ion guide 19 of the present example will be described in detail with reference to FIG. 20. For convenience, description of parts common to those of the above-described examples may be omitted. As described in each of the above-described examples, when the plate electrodes 25 made of metal are stacked at a close distance, the capacitance between the plate electrodes increases, and it becomes difficult to manufacture the power source 9 for applying radio-frequency voltages. The capacitance is proportional to the proximity area and inversely proportional to the proximity distance.

In the present example, the surface area of the plate electrode is reduced by a hole 38 of a member of the plate electrode 25 cut out (e.g., in a region as wide as possible), whereby a reduction in capacitance can be achieved. The hole 38 is formed as a hole penetrating the plate electrode 25 in the stacking direction, for example.

The same effects as those of Example 1 can be obtained by the configuration of Example 13 described above. In particular, this configuration has an effect of suppressing capacitance between electrodes.

### (Example 14) (Conductor Layer in Insulator)

In Example 14, a configuration of an ion guide including a plate electrode having a conductor layer on a base material surface of an insulator will be described.

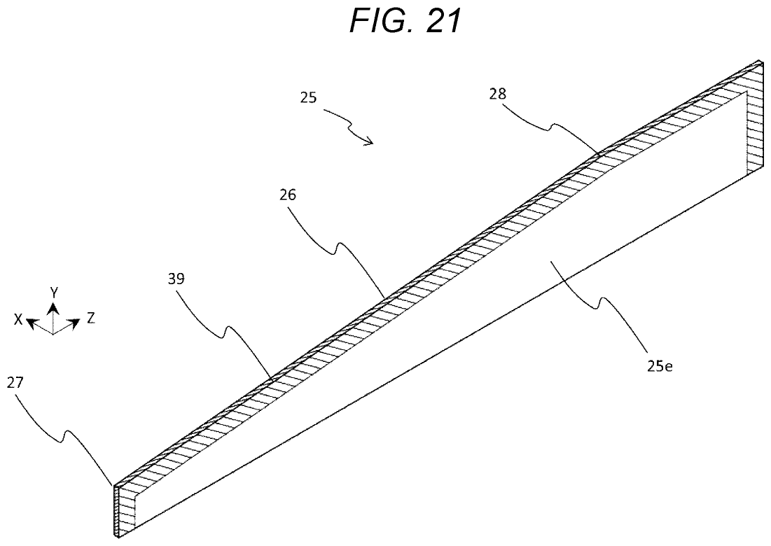

The ion guide 19 of the present example will be described in detail with reference to FIG. 21. For convenience, description of parts common to those of the above-described examples may be omitted. The plate electrode 25 described in each of the above-described examples can be made of, for example, metal as a whole. In contrast, the plate electrode 25 of the present example has a feature that a surface of an insulator 25e serving as a base material includes a conductor layer 39 (hatched part in FIG. 21). That is, the plate electrode 25 includes the insulator 25e and the conductor layer 39 that is formed on a part of the surface of the insulator 25e.

Ceramic, plastic, or the like can be used for the insulator 25e. A metal layer can be used for the conductor layer 39. Methods of forming the conductor layer 39 on the surface of the insulator 25e include vapor deposition, plating, and adhesion.

In the plate electrode 25 of the present example, the surface area of a part of the conductor layer 39 made of metal can be made very small. Therefore, the capacitance between the electrodes can be reduced similarly to Example 13.

The conductor layer 39 is preferably formed on the electrode surface (surface facing the internal space 29, orthogonal to the stacking direction, and including the inclined surface 26) of the plate electrode 25. As illustrated in FIG. 21, by further forming the conductor layer 39 also on a surface (portion that can be hit by ions) in the vicinity of the electrode surface, it is possible to prevent charge up of the insulator 25e.

The same effects as those of Example 1 can be obtained by the configuration of Example 14 described above. In particular, this configuration has an effect of suppressing capacitance between electrodes.

### (Example 15) (Plurality of Direct-Current Voltages)

In Example 15, a configuration of an ion guide in which different direct-current voltages are applied to the inside plate electrodes and the outside plate electrodes will be described.

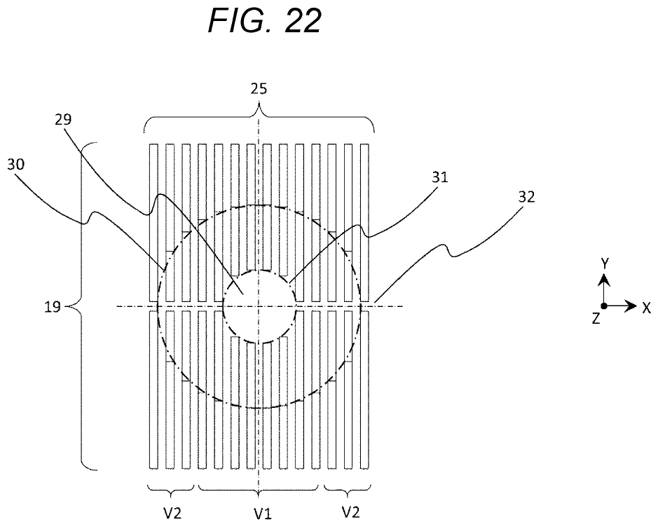

The ion guide 19 of the present example will be described in detail with reference to FIG. 22. For convenience, description of parts common to those of the above-described examples may be omitted. The present example has a feature that different direct-current voltages are applied to the plate electrodes 25 inside and outside in the X direction.

For example, by making a direct-current voltage V2 on the outside higher than a direct-current voltage V1 on the inside, an effect of collecting ions in a center direction in the X axis can be expected. Note that it is sufficient that even only one set has a combination of the values of the direct-current voltage different between the inside and the outside. All different direct-current voltages may be applied to the plate electrodes 25, such as increasing stepwise or monotonically from the inside toward the outside.

The same effects as those of Example 1 can be obtained by the configuration of Example 15 described above. In particular, this configuration has an effect of focusing ions at the ion guide center.

In addition to or in place of varying the direct-current voltages in the X direction as in Example 15, the direct-current voltages may be changed in the up-down direction (Y direction). In this manner, it is possible to deflect ions in the Y direction, and in particular, this is also effective as an auxiliary function when deflecting ions as in Example 6.

### (Example 16) (Airflow Cover)

In Example 16, a configuration of an ion guide having a cover for suppressing outflow of an airflow on the outside of the plate electrode will be described.

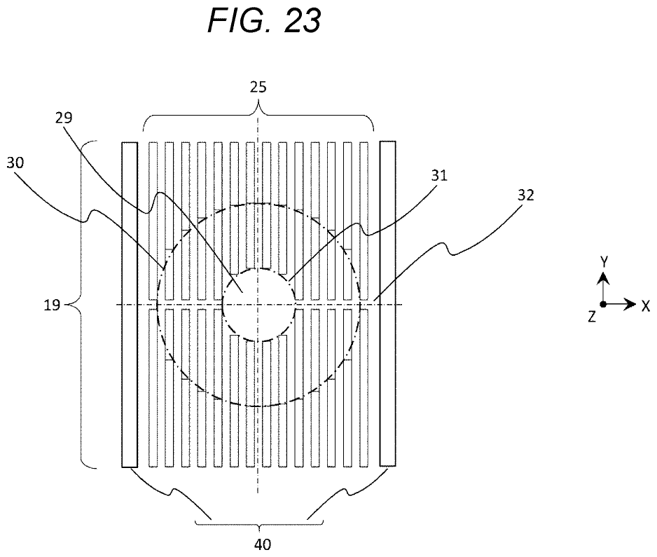

The ion guide 19 of the present example will be described in detail with reference to FIG. 23. For convenience, description of parts common to those of the above-described examples may be omitted. The present example has a feature of including a cover 40 suppressing outflow of an airflow outside in the X direction of the plate electrode 25. This configuration can suppress excessive outflow of the airflow from the ion guide 19. As a result, can prevent ions from flowing out to the outside of the ion guide 19 on the airflow, leading to an increase in sensitivity.

The cover 40 may be an integrated component with the outermost plate electrode 25. FIG. 23 illustrates an example in which the cover 40 is installed in the X direction. Alternatively, the cover 40 may be provided outside in the Y direction, or may be provided in both the X direction and the Y direction.

The same effects as those of Example 1 can be obtained by the configuration of Example 16 described above. In particular, this is effective in an increased sensitivity.

### (Example 17) (Oblique Arrangement)

In Example 17, a configuration in which the stacking direction of the plate electrodes is inclined with respect to the X direction will be described.

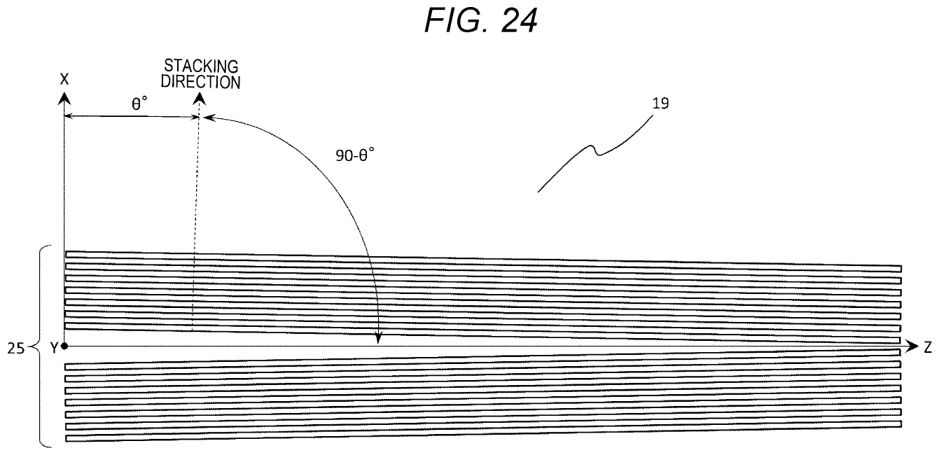

The ion guide 19 of the present example will be described in detail with reference to FIG. 24. For convenience, description of parts common to those of the above-described examples may be omitted. The present example has a feature that the stacking direction of the plate electrodes 25 is inclined by θ [degrees] (where θ≠0) with respect to the X direction. That is, the plate electrodes 25 are stacked in a direction forming an angle of 90-θ [degrees] with respect to the Z direction.

The inlet side of the internal space is widened when θ>0, and the outlet side of the internal space is widened when θ<0. Under the condition of θ>0, it is expected that the introduction area of ions is widened by widening the inlet side and the introduction efficiency into the ion guide 19 is improved. On the other hand, under the condition of θ<0, since the outlet side becomes wider, it is possible to reduce collision of ions and airflows with the plate electrodes 25, and it is expected to reduce loss of ions due to the collision.

When the absolute value of θ is too large, the distance of the plate electrode 25 is too large at the center part and the electric field becomes weak. Therefore, it is desirable to set the degree within a range of −15≤θ≤15 (i.e., stacked in a direction forming an angle within a range of 75 degrees to 105 degrees with respect to the Z direction). It is more desirable to set the degree within a range of −10≤θ≤10 (i.e., stacked in a direction forming an angle within a range of 80 degrees to 100 degrees with respect to the Z direction). It is still more desirable to set the degree within a range of −5≤θ≤5 (i.e., stacked in a direction forming an angle within a range of 85 degrees to 95 degrees with respect to the Z direction).

The same effects as those of Example 1 can be obtained by the configuration of Example 17 described above. In particular, this configuration has an effect of improvement in ion introduction efficiency or reduction in ion loss due to collision.

The ion guide of the present invention is not limited to those according to Examples 1 to 17 described above. For example, regarding the inscribed shape, other than the inscribed shape described above, various shapes (e.g., the inlet side is circular and the outlet side is square) can be achieved in accordance with the inclined surface of the plate electrode. Thus, it is possible to handle ion guides having various patterns of inscribed shapes.

Regarding the device configuration of each of the examples described above, similar effects can be obtained even in a device form in which the feature elements of each of the device configurations are combined.

Implementation of the ion guide in which the plate electrodes are stacked can be modularized by a fixing means such as a screw using a spacer component that can hold a stacking interval or a pin component that determines the positional relationship between the plate electrodes. It is also possible to assemble the ion guide using an assembly jig or the like. The plate electrode can be directly attached and fixed to a base component (such as a holder), an electric circuit board (for applying a radio-frequency voltage or a direct-current voltage), or the like by welding, bonding, or the like. Other than a method of assembling the plate electrode in which an inclined surface is formed in advance, it is also possible to assemble the plate electrode without an inclined part, and then postprocess the shape such as a tapered shape inside the ion guide by wire cut electrical discharge machining, die electrical discharge machining, or the like.

### REFERENCE SIGNS LIST

1 mass spectrometer
2 ion source
3 mass spectrometry unit
4 vacuum vessel
5 ion generation unit
6 ion source chamber
7 introduction electrode
8 hole
9 power source
10 control unit
11 to 13 vacuum chamber
14 to 15 hole
16 to 18 vacuum pump
19 ion guide
20 ion transport unit
21 ion analysis unit
22 detector
23 counter electrode
24 hole
25 plate electrode
25a to 25d plate electrode group
25e insulator
26 inclined surface
27 inclination start point
28 inclination end point
29 internal space
30 to 31 inscribed shape
32 interval
34 to 36 inscribed shape
37 outlet barycenter position
38 hole
39 conductor layer
40 cover

All publications, patents, and patent applications cited in the present description are hereby incorporated by reference in their entirety.

1. An ion guide in which an ion travels in an internal space from an inlet side toward an outlet side, wherein
the ion guide includes a plurality of plate electrodes,
the plurality of plate electrodes is stacked at intervals in a stacking direction orthogonal to a traveling direction in which the ion travels,
at least two plate electrodes, in the plurality of plate electrodes, are inclined plate electrodes having an inclined surface inclined with respect to the traveling direction in a part facing the internal space,
each of the inclined plate electrodes has an inclination start point at which the inclined surface starts on an end surface on the inlet side, and
positions of the inclination start points in a direction orthogonal to both the traveling direction and the stacking direction are different for at least two of the inclined plate electrodes adjacent in the stacking direction.

2. The ion guide according to claim 1, wherein
each the inclined plate electrodes has an inclination end point at which the inclined surface ends in a part facing the internal space, and
positions of the inclination end points in the traveling direction are different for at least two of the inclined plate electrodes adjacent in the stacking direction.

3. The ion guide according to claim 1, wherein
the ion guide is connected to a power source configured to apply radio-frequency voltages having opposite phases to each other between the plate electrodes adjacent in the stacking direction, and
a multipolar electric field is formed in the internal space by application of the radio-frequency voltages by the power source.

4. The ion guide according to claim 3, wherein a number of the plate electrodes effectively contributing to formation of the multipolar electric field and a number of poles of the multipolar electric field are smaller on the outlet side than on the inlet side.

5. The ion guide according to claim 3, wherein an area of an inscribed shape of the plate electrodes forming the multipolar electric field is smaller on the outlet side than on the inlet side.

6. The ion guide according to claim 3, wherein a barycenter of an inscribed shape of the plate electrodes forming the multipolar electric field is eccentric between the inlet side and the outlet side.

7. The ion guide according to claim 1, wherein each of the plate electrodes includes an insulator and a conductor layer that is formed on a part of a surface of the insulator.

8. The ion guide according to claim 1, wherein the position of the inclination start point of each of the inclined plate electrodes changes in accordance with a monotonous change function in a broad sense, from an outside to an inside of the stacking direction.

9. The ion guide according to claim 1, wherein the stacking direction orthogonal to the traveling direction is a direction forming an angle within a range of 75 degrees to 105 degrees with respect to the traveling direction.

10. A mass spectrometer comprising the ion guide according to claim 1.
